(19) United States
(12) Patent Application Publication
(10) Pub. No.: US 2013/0341135 A1
(43) Pub. Date: Dec. 26, 2013

(54) BRAKE BACKING PLATE WITH STEP-CHAMFER

(71) Applicants: Ray ARBESMAN, Toronto (CA); Nghi PHAM, Concord (CA)

(72) Inventors: Ray ARBESMAN, Toronto (CA); Nghi PHAM, Concord (CA)

(21) Appl. No.: 13/927,815

(22) Filed: Jun. 26, 2013

(30) Foreign Application Priority Data
Jun. 26, 2012 (CA) 2,781,540

(51) Int. Cl. F16D 65/092

(52) U.S. Cl. CPC F16D 65/092
USPC 188/250 H

(57) ABSTRACT

A brake plate is provided that has a substantially planar metallic body with a first friction facing surface, a second opposing caliper facing surface, a pair of relatively long edges, and a pair of relatively short edges. At least one of the long edges has a step-chamfer.

### CROSS-REFERENCE TO RELATED APPLICATIONS

This application claims benefit of Canadian patent application number 2,781,540, filed Jun. 26, 2012, which is herein incorporated by reference.

### BACKGROUND OF THE INVENTION

1. Field of the Invention

The invention relates to backing plates for use in disc brake pads.

2. Description of the Related Art

Modern vehicle brake systems allow for slowing or stopping movement of the vehicle in a controlled manner. A typical automobile or light truck brake system includes a disc brake assembly for each of the front wheels and either a drum brake assembly or a disc brake assembly for each of the rear wheels. The brake assemblies are actuated by hydraulic or pneumatic pressure generated when an operator of the vehicle depresses a brake pedal. The structures of these drum brake assemblies and disc brake assemblies, and their actuators, are well known in the art.

A typical disc brake assembly includes a rotor which is secured to the wheel of the vehicle for rotation therewith. The rotor has a pair of opposed friction plates which are selectively engaged by portions of a caliper assembly. The caliper assembly is slidably supported by pins secured to an anchor plate. This anchor plate is in turn secured to a non-rotatable component of the vehicle, such as the vehicle frame. A pair of brake pads (shoes) are disposed in the caliper assembly on opposite sides of the rotor. These brake pads are operatively connected to one or more hydraulically actuated pistons for movement between a non-braking position, wherein they are spaced apart from the opposed friction plates of the rotor; and a braking position, wherein they are moved into frictional engagement with the opposed friction plates of the rotor. Depressing the brake pedal causes the piston to urge the brake pads from the non-braking position to the braking position, frictionally engaging the friction plates to the rotor and thereby slowing or stopping the rotation of the associated wheel of the vehicle.

The brake caliper is typically a cast solid piece of iron, steel or aluminum. The casting process leaves rounded interior edges. In order to provide corner clearance with these rounded interior edges, the brake pads, themselves planar and angular, are frequently chamfered on one edge where the mounted pad faces the interior corner of the caliper.

The classic chamfer on the backing plate portion of the brake pad is an angled surface on the leading edge of the plate that substantially mirrors (or at least provides complementary geometry with) the rounded angled surface in the interior corners of the caliper. The chamfer and the corner of the caliper, lacking points of potential unwanted contact, thus have clearance from each other. However, such chamfered edges, while elegant, are not easy to produce, particularly on brake backing plates having a rounded or other irregular shaped leading edge.

Further, although routinely manufactured for backing plates, the chamfered angle is not needed for every shape of caliper. Therefore, an extra costly and time-consuming secondary step is often needlessly included. Chamfering has become an ingrained and expected part of the manufacturing process for backing plates.

It would be desirable to provide a simple alternative to the complex chamfer.

### SUMMARY OF THE INVENTION

According to an aspect of the invention, a brake plate is provided that has a substantially planar metallic body with a first friction facing surface, a second opposing caliper facing surface, and a pair of relatively long edges and a pair of relatively short edges. At least one of the long edges has a step-chamfer. The step-chamfer is preferably proximate to the second caliper facing surface.

Preferably, the step-chamfer has one step. Preferably, the step is substantially L-shaped. Preferably, the step-chamfer extends along the full length of the plate. In one embodiment, the step-chamfered edge is rounded along its length.

Preferably, the plate is an integrally molded brake plate. Preferably, the plate is formed to receive friction material on the first friction facing surface, and the friction material does not contact the step-chamfer.

Preferably, the plate is sized to fit in a brake caliper, such that the step-chamfered edge will sit adjacent to an inside corner or radius of the caliper. Preferably, the step-chamfer is sized to allow clearance for the plate to sit adjacent to the corner or radius of the caliper.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIGS. 1-2 are views (front perspective and partial section, respectively) of the prior art angle chamfer on a brake backing plate.

FIG. 3 is a front perspective view of the brake backing plate with step-chamfer.

FIG. 4 is a top view of the leading edge showing step-chamfer.

FIG. 5 is a partial sectional view of FIG. 4 showing the step-chamfer.

FIG. 6 is a front view of the brake backing plate with the step-chamfer.

FIG. 7 is a side view of the brake backing plate with the step-chamfer.

FIG. 8 is a side view of brake pads using the step-chamfer mounted in a simplified caliper.

FIG. 9 is a detailed view of the circled area of FIG. 8.

### DETAILED DESCRIPTION

A brake plate is provided that has a substantially planar metallic body. The body has a first friction facing surface and a second caliper facing surface, and a pair of relatively long edges and a pair of relatively short edges. At least one of the long edges has a step-chamfer.

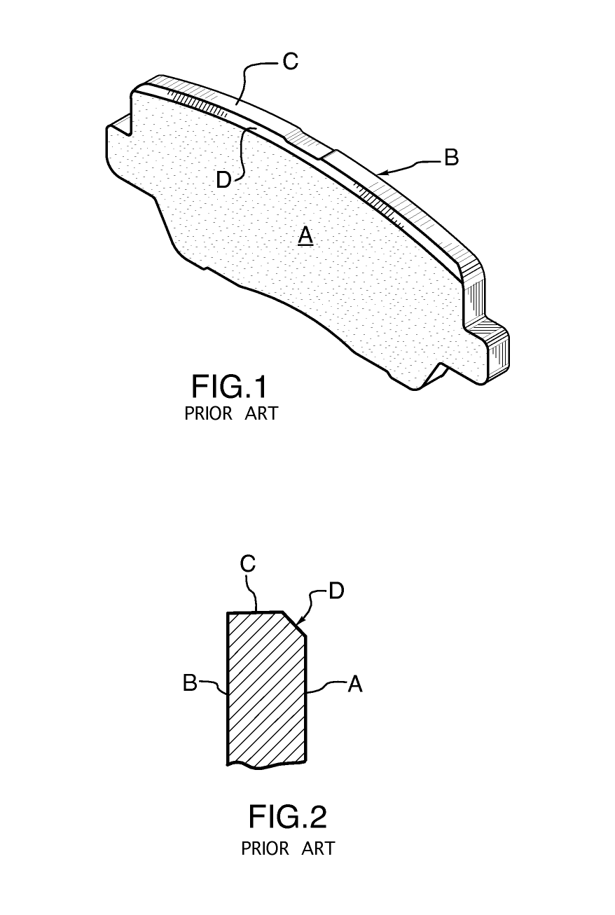

As shown in FIGS. 1 and 2, prior art chamfers use an angled surface D on the corner of the leading edge C facing the caliper facing surface A. Typically, this is approximately a 45° angle. It serves to provide clearance for the leading edge in the inside corner of the caliper in which the plate is to be mounted. Surface B of the plate receives the friction material and does not typically have a chamfer.

The angle chamfer is typically made by grinding or mill-cutting the leading edge. Besides being an expensive and time-consuming secondary operation, the angle chamfer can be particularly difficult to produce where the leading edge C is rounded along its length (i.e. where the top of the brake backing plate is arcuate from edge to edge) or has recessed areas or other edge features (as shown in FIG. 1).

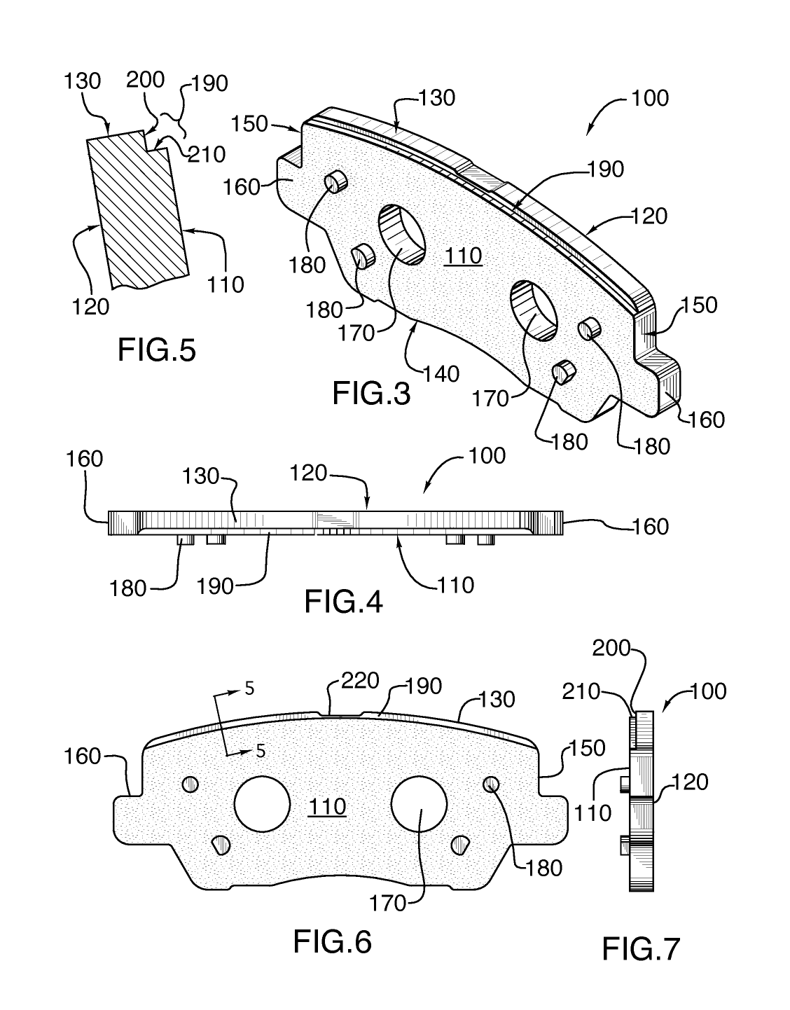

By contrast, the step-chamfer shown in FIGS. 3-7 allows the same clearance objective to be met, while the design has manufacturing simplicity across a variety of plate applications and requirements. The angular ledge of the step-chamfer could also be used as a further gripping or attachment surface (e.g. for tabbed or clipped shims).

Turning to FIGS. 3-7, the plate 100 is a relatively thick, substantially planar metallic body (e.g. steel). The plate has generally two faces—a first caliper-facing surface 110, and a second friction-facing surface 120. The backing plate is one portion of the brake pad. The backing plate is attached to a friction material (typically a molded composite material that is attached to the plate with one or a combination of rivets, adhesive, integral-molding, or frictional attachment—e.g. NRS®). The plate shown in the figures is an IM (integrally molded) plate, having integral-molding holes 170 into which friction material flows and hardens to solidify and retain friction material on the surface 120. It will be appreciated that the plate may alternatively be a solid body plate (having no integral-molding holes) and may have other friction-attaching surface features, the details of which are known in the art, and are not generally within the scope of the present invention. (Note that the friction material in any of these methods does not extend all the way out to the edges of the plate. An exposed gap is maintained around the perimeter of the plate.)

The shapes and dimensions of brake backing plates vary widely depending on application. The shape shown in the drawings is merely exemplary of one type for certain models of passenger vehicles, but the invention is not limited to this type/application. A backing plate can be thought of as having two long sides—leading edge 130 and trailing edge 140—and two identical short sides (here, both labelled 150). The short sides may have abutments 160 in certain embodiments. (The abutments are exposed mounting extensions that are not covered by friction material and are used for installation and retention of the brake pad in certain caliper designs.) The leading and trailing edges of the backing plate may also have other recesses (e.g. 220), projections (e.g. 180), and other surface features as may be required for particular applications and/or to provide clearance for other mounting or wear sensor hardware, springs, shims, etc.

The step-chamfer 190 is generally provided at the corner of the plate where leading edge 130 meets surface 110. (NB: This is an area not covered by the friction material.) The step-chamfer is preferably substantially L-shaped, having one step. As shown in FIG. 5, in cross-section, horizontal offset 210 and vertical offset 200 are preferably substantially flat and generally perpendicular to each other. The offset distances of the step-chamfer surfaces 210 and 200 may be substantially the same length (as shown) (thereby approximating the effect of a 45° angle chamfer), or have distances of different lengths as may be preferred to provide other clearance angles. The offsets may or may not be perpendicular to each other. Also, the offset distance of surface 200 may be varied along its length, approximating a compound chamfer. The step-chamfer may be multi-step or single-step. Further, although flat offsets are described, it will be appreciated that one or both of 200, 210 (or the step-chamfer 190 as a whole) may be rounded or filleted (e.g. having a “scooped out” profile). The ability to modify the shape and dimensions easily to achieve different effects is an advantage of the present invention.

Various dimensions are possible. Preferably, the step-chamfer does not extend into the plate more than half the overall thickness of the plate. Preserving a certain minimum plate thickness may be necessary to protect the integrity of the leading edge 130 of the plate which is an exposed contact area.

Various methods of making the step-chamfer are possible (e.g. forming or stamping methods, grinding, cutting, notching, carving, fine-blanking, etc.) and are beyond the scope of the present disclosure. Due to its simplicity, the step-chamfer may be able to be produced at the same time as other features on the plate, without a separate specialized operation.

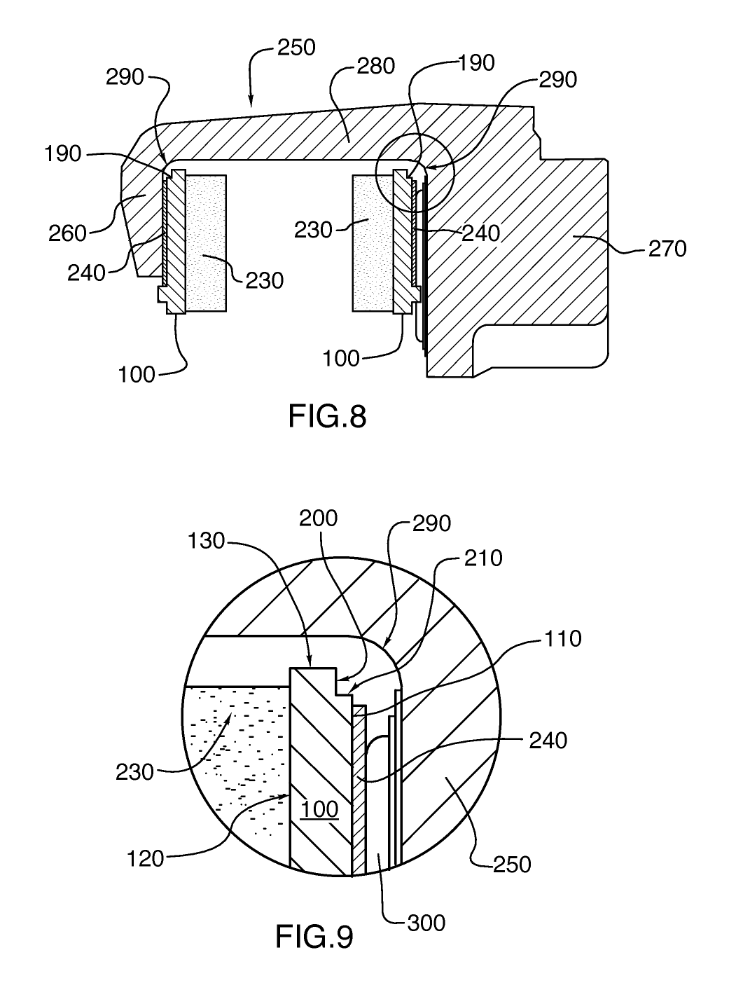

Turning to FIGS. 8 and 9; when the step-chamfered plate is ready to receive a friction material 230, this is applied on surface 120. The finished brake pads bearing friction material 230 are mounted in the caliper 250. The friction material provides an engagement surface for mating against the rotor in braking.

In FIG. 8, the brake pads are shown mounted in the caliper (shown in simplified outline for ease of understanding). The caliper 250 has a first end 260, second end 270 and a bridge section 280 there between. The cylinder is generally defined in the end 270 and a piston 300 presses the pads generally together to contact a rotor (not shown).

The caliper 250 is typically a cast piece/assembly that may be machined in certain areas to remove surface pebbling, irregularities and rough edges, but generally is not machined to any great extent (or at all) in the interior corner areas 290. In order to maintain overall stiffness of the caliper, thicker sections in the corners 290 of the caliper are believed necessary. Maintaining thickness in these areas is believed to be critical in reducing stress fractures and caliper breakage. As an artefact of the casting process, which is uncorrected by machining, the inside “corners” 290 are actually generally arcuate and thus provide a difficult fit for the plate corners. The step-chamfer 190 on the plate allows clearance for the corner 290 regardless of the corner's specific radius and allows considerable leeway for various casting imperfections.

A shim 240 may be provided on the piston-facing surface 110 of the plate 100 to reduce NVH (noise, vibration and harshness) incident in braking. The shim, if provided, will be smaller than the outside dimensions of the plate, thus not ordinarily contacting the chamfered edge or the inside corner of the caliper. However, it is possible that a tab of the shim may extend into and grab onto the step-chamfer as a further gripping surface. The step-chamfer may be provided with particular recesses or other attachment surfaces specifically for this purpose. The geometry of the step-chamfer is easy to modify for such features.

The foregoing description illustrates only certain preferred embodiments of the invention. The invention is not limited to the foregoing examples. That is, persons skilled in the art will appreciate and understand that modifications and variations are, or will be, possible to utilize and carry out the teachings of the invention described herein. The scope of the claims should not be limited by the preferred embodiments set forth in the examples, but should be given the broadest purposive construction consistent with the description as a whole.

1. A brake plate comprising a substantially planar metallic body having:
a first friction facing surface;
a second opposing caliper facing surface; and
a pair of relatively long edges and a pair of relatively short edges;
wherein at least one of the long edges has a step-chamfer.

2. The brake plate of claim 1, wherein the step-chamfer is proximate to the second caliper facing surface.

3. The brake plate of claim 1, wherein the step-chamfer has one step.

4. The brake plate of claim 3, wherein the step is substantially L-shaped.

5. The brake plate of claim 1, wherein the step-chamfer extends along the full length of the plate.

6. The brake plate of claim 1, wherein the step-chamfered edge is rounded along its length.

7. The brake plate of claim 1, wherein the plate is an integrally molded brake plate.

8. The brake plate of claim 1, wherein the plate is formed to receive friction material on the first friction facing surface, and the friction material does not contact the step-chamfer.

9. The brake plate of claim 1, wherein the plate is sized to fit in a brake caliper, such that the step-chamfered edge will sit adjacent to an inside corner or radius of the caliper.

10. The brake plate of claim 9, wherein the step-chamfer is sized to allow clearance for the plate to sit adjacent to the corner or radius of the caliper.
